(19) United States
(12) Patent Application Publication
(10) Pub. No.: US 2011/0206951 A1
(43) Pub. Date: Aug. 25, 2011

(54) HYBRID VEHICLE BATTERY HEATER BY EXHAUST GAS RECIRCULATION

(76) Inventors: Peter Ford, Laguna Niguel, CA (US); Kenneth J. Newell, Irvine, CA (US)

(21) Appl. No.: 12/712,885

(22) Filed: Feb. 25, 2010

(51) Int. Cl. H01M 10/50; F02M 25/07

(52) U.S. Cl. 429/50; 123/568.12; 180/65.29

(57) ABSTRACT

An exhaust gas recirculation circuit with an engine having an intake manifold and an exhaust manifold, a heat exchanger having an inlet in selective fluid communication with the exhaust manifold and an outlet in fluid communication with the intake manifold, wherein the heat exchanger is in a heat exchange relationship with at least a portion of a battery. A method of managing a battery of a hybrid vehicle by sensing a temperature of the battery; comparing the sensed temperature with a lower threshold; if the battery temperature is less than a lower threshold, flowing exhaust gasses from an engine to a heat exchanger in a heat exchange relationship with at least a portion of the battery; if the battery temperature is greater than the lower threshold, utilizing the battery.

### BACKGROUND

### Field

This disclosure relates to vehicles using batteries. In particular, this disclosure relates to managing the temperature and utilization of a battery in a hybrid combustion and electric vehicle.

### SUMMARY

According to some exemplary implementations, an exhaust gas recirculation circuit is disclosed, comprising: an engine having an intake manifold and an exhaust manifold; and a heat exchanger having an inlet in selective fluid communication with the exhaust manifold and an outlet in fluid communication with the intake manifold, wherein the heat exchanger is in a heat exchange relationship with at least a portion of a battery.

The exhaust gas recirculation circuit may further comprise an outlet of the heat exchange in fluid communication with the intake manifold of the engine. The exhaust gas recirculation circuit may further comprise a vent line between the exhaust manifold and the heat exchanger configured to controllably flow at least a portion of the exhaust gasses out of the vehicle. The vent line may lead to a catalytic converter and a tailpipe. The heat exchanger may be in a heat exchange relationship with cells of the battery. The exhaust gas recirculation circuit may further comprise a bypass valve between the exhaust manifold and the intake manifold. The exhaust gas recirculation circuit may further comprise a cooling source in fluid communication with the heat exchanger and configured to selectively provide coolant to the heat exchanger. The exhaust gas recirculation circuit may further comprise a bypass line between the exhaust manifold and the intake manifold configured to controllably flow at least a portion of the exhaust gasses from the exhaust manifold to the intake manifold.

According to some exemplary implementations, a method of managing a battery of a hybrid vehicle is disclosed, comprising: sensing a parameter of the battery; comparing the sensed parameter with a lower threshold; if the sensed parameter is less than a lower threshold, flowing exhaust gasses from an engine to a heat exchanger in a heat exchange relationship with at least a portion of the battery; and if the sensed parameter is greater than the lower threshold, utilizing the battery.

The predetermined threshold may correspond to a threshold for satisfying a preferred range of performance characteristics of the battery. The sensed parameter may be at least one of temperature, impedance, state of charge, age, and historical usage of the battery. Utilizing the battery may further comprise supplying electrical power from the battery to an electric motor, whereby the vehicle is powered by the electric motor. The method may further comprise flowing exhaust gasses from the heat exchanger to an intake of the engine. The method may further comprise comparing the sensed parameter with an upper threshold. The method may further comprise if the sensed parameter is greater than the upper threshold, flowing coolant from a cooling source to the heat exchanger, whereby the temperature of the battery is lowered. The method may further comprise if the sensed parameter is between the lower threshold and the upper threshold, utilizing the battery.

According to some exemplary implementations, a method of managing a battery of a hybrid vehicle is disclosed, comprising: sensing a temperature of the battery; comparing the sensed temperature with a lower threshold and an upper threshold; if the battery temperature is less than the lower threshold, flowing exhaust gasses from an engine to a heat exchanger in a heat exchange relationship with at least a portion of the battery, whereby the temperature of the battery is raised; if the battery temperature is greater than the upper threshold, flowing coolant from a cooling source to the heat exchanger, whereby the temperature of the battery is lowered; and if the battery temperature is between the lower threshold and the upper threshold, utilizing the battery.

Utilizing the battery may further comprise supplying electrical power from the battery to an electric motor, whereby the vehicle is powered by the electric motor. The method may further comprise flowing exhaust gasses from the heat exchanger to an intake of the engine.

### DRAWINGS

The above-mentioned features of the present disclosure will become more apparent with reference to the following description taken in conjunction with the accompanying drawings wherein like reference numerals denote like elements and in which:

FIG. 1 shows a graph illustrating an impact of temperature (° C.) on internal resistance (ohms) for various states of charge (SOC) of an NiMH battery, according to some exemplary implementations;

FIG. 2 shows a graph illustrating an impact of temperature (° C.) on maximum discharge power (watts) for a given state of charge (55%) of an NiMH battery, according to some exemplary implementations;

FIG. 3 shows a graph illustrating an impact of capacity (Ah) on voltage (V) for various states temperature states (° C.) of a Li-ion battery, according to some exemplary implementations;

FIG. 4 shows a block diagram of a system for managing the temperature of a vehicle battery;

FIG. 5 shows a block diagram of a system for managing the temperature of a vehicle battery;

FIG. 6 shows a block diagram of a system for managing the temperature of a vehicle battery;

FIG. 7 shows a flow chart for managing the temperature and utilization of a vehicle battery; and

FIG. 8 shows a flow chart for managing the temperature and utilization of a vehicle battery.

### DETAILED DESCRIPTION

A battery's performance characteristics may be altered by its temperature. During low ambient or internal temperatures, a battery's capability to provide power may be decreased. To improve the power output from a battery, the internal temperature may be raised. Traditional methods and structures for heating a battery may include electric heaters, introducing AC signals through the battery, inter alia. Such traditional methods and structures may external and additional power input, decreasing the net gain of power achieved with a higher battery temperature.

In automotive applications, a battery may be a power source for an electric motor, such as part of a hybrid system. Prior to startup of a system, a battery's temperature may have reached equilibrium with an ambient temperature lower than one that provides optimal performance characteristics for the battery. In such a case, using the battery initially during startup of the system may be less efficient.

Automotive engines, such as internal combustions engines, may have an exhaust gas recirculation circuit to improve the emissions or fuel economy of a vehicle. Exhaust gas recirculation (EGR) is may facilitate reduction of nitrogen oxide (NOx) emissions occurring in many gasoline (petrol) and diesel engines. In EGR, at least a portion of an engine's exhaust gas may be recirculated back to the engine cylinders. This may serve beneficial purposes in certain engines. In a gasoline engine, for example, the inert exhaust displaces the amount of combustible matter in the cylinder, thereby reducing the heat of combustion. At lower heat, the combustion may generate the same pressure against the piston at a lower temperature. In a diesel engine, for example, the exhaust gas replaces some of the excess oxygen in the pre-combustion mixture.

According to some exemplary implementations, an additional, enhanced, or modified circuit may be included to allow exhaust gas to heat the battery directly or indirectly through a fluid (gas or liquid) medium.

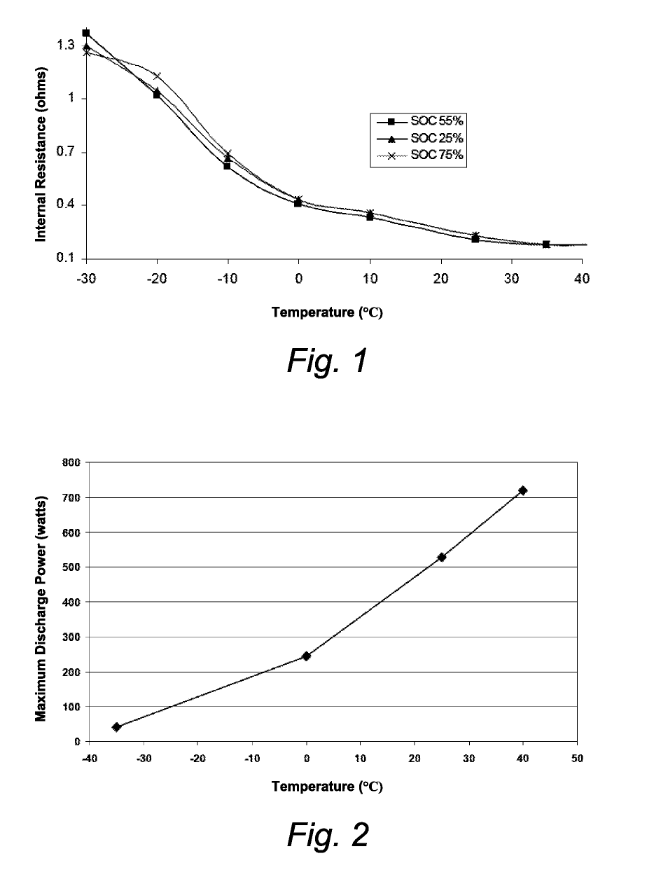

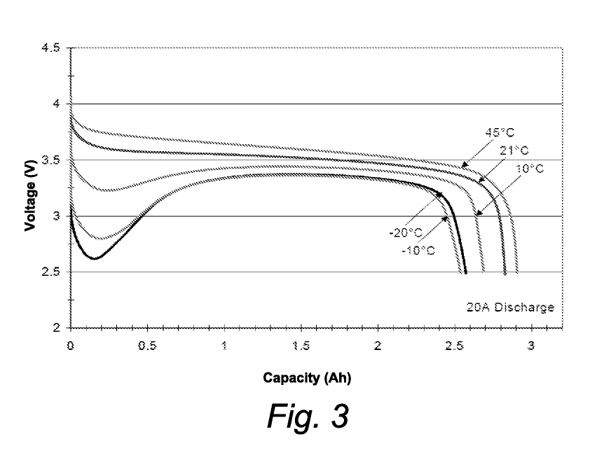

According to some exemplary implementations, batteries may have variable operating characteristics based on conditions and environment of the batteries. For example, the impedance (i.e., internal resistance) of a battery may vary based on the temperature of the battery. By further example, the impedance of a battery may vary based on the state of charge (i.e., percentage of total charge capacity) of the battery. As shown in FIG. 1, temperature (° C.) may have an impact on internal resistance (ohms) for various states of charge (SOC) of an NiMH battery. These and other environmental conditions may further have an impact on other operating characteristics of the battery. For example, as further shown in FIG. 2, temperature (° C.) may have an impact on maximum discharge power (watts) of an NiMH battery. According to some exemplary implementations, as shown in FIG. 3, voltage (V) as compared to capacity (Ah) of a Li-ion battery tends to be greater at higher temperatures. Those having ordinary skill in the art may recognize specific characteristics of any given battery and the effect of conditions and environment thereon.

According to some exemplary implementations, ranges of temperatures may be established, each representing general categories of battery performance. For example, about 0 to about 35° C. (and greater) may correspond to an optimal range of temperatures; about 0 to about −20° C. may correspond to a range of reduced power; about −20 to about -36° C. may correspond to a range of greatly reduced power; about −36° C. and lower may correspond to a range of substantially low or no power. These or other ranges may be predetermined to decide whether intervention is taken to alter at least the temperature of a battery to enhance its performance characteristics.

The precise performance characteristics of a battery may vary with the type of battery. For example, alkaline, lead-acid, nickel-cadmium (NiCd), nickel metal hydride (NiMH), lithium-ion (Li-ion), and lithium-ion polymer (Li-poly) may each have somewhat unique and determinable performance characteristics. Each battery using an electro-chemical reaction may vary its operation based on at least the temperature thereof. Other characteristics of the battery may further alter its performance characteristics, and may accordingly be considered by devices and methods of the present disclosure. For example, performance characteristics of batteries may change as a function of age, as a function of usage (charge-discharge cycles), or as a function of state of charge. Accordingly, these and other considerations may factor into devices and methods of the present disclosure. Sensing, measuring, calculating, and recording devices and methods are contemplated to support such considerations.

According to some exemplary implementations, a preferred range of operating temperatures may be determinable for any given battery. For example, some molten salt batteries, which use molten salts as an electrolyte, may have operating temperatures of 400° C. to 700° C. Certain designs, such as a ZEBRA battery, may operate at a temperature range of 270° C. to 350° C.

As shown in FIG. 1, internal resistance or impedance trends may vary based on the state of charge of a battery. Accordingly, the state of charge and other conditions may be taken into consideration to determine whether intervention is taken to alter at least the temperature of a battery to enhance its performance characteristics.

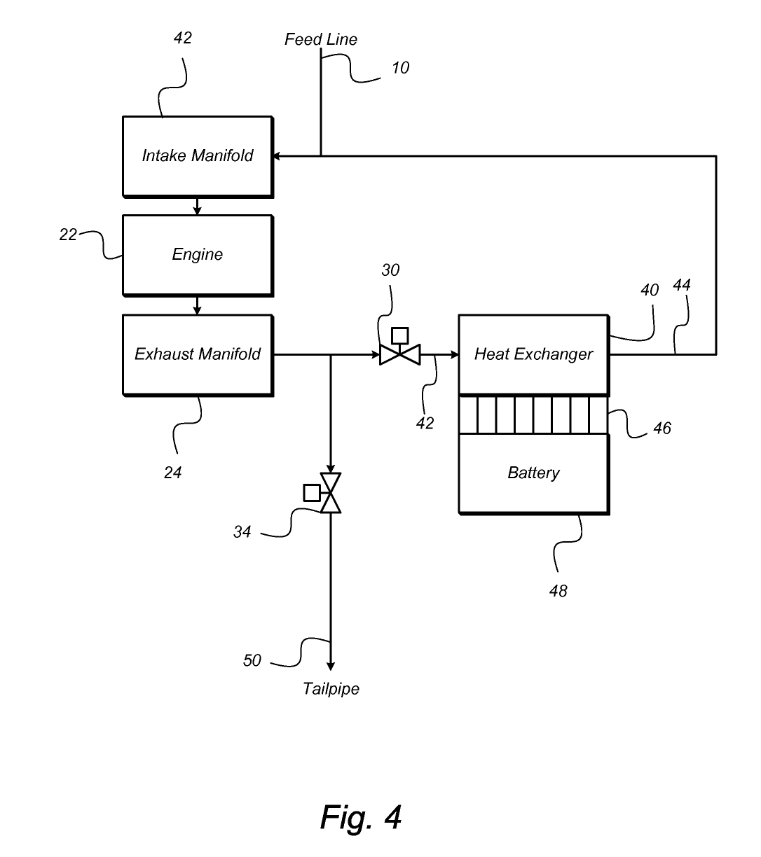

According to some exemplary implementations, as shown in FIG. 4, engine 22 has intake manifold 20 and exhaust manifold 24. Intake manifold 20 may be configured to evenly distribute the combustion mixture to each intake port of the cylinder head(s) of engine 22. Exhaust manifold 24 may collect engine exhaust from one or more cylinders of engine 22 and deliver it to an exhaust pipe. Exhaust manifold 24 may be configured to decrease flow resistance (back pressure) and to increase the efficiency of engine 22.

According to some exemplary implementations, as shown in FIG. 4, exhaust manifold 24 may be in fluid communication with heat exchanger 40. Heat exchanger 40 may include inlet 42 and outlet 44. Heat of exhaust gasses received from exhaust manifold 24 to heat exchanger 40 may be communicated via heating/cooling plates 46 to at least a portion of battery 48. According to some exemplary implementations, other methods and structures for transferring heat of exhaust gasses to at least a portion battery 48. For example, any number of heat exchange methods and devices may be provided, as shall be recognized by those having skill in the relevant art.

According to some exemplary implementations, at least one valve may be provided to selectively control the flow of fluids within a system. For example, as shown in FIG. 4, battery valve 30 may be provided between exhaust manifold 24 and inlet 42 of heat exchanger 40. First vent valve 34 may be provided to selectively connect exhaust manifold 24 to a vent line 50. Other devices and methods of controlling flow are contemplated, including devices that selectively divide the flow from exhaust manifold 24 to heat exchanger 40 and vent line 50 according to the proportion of flow desired to be passed to heat exchanger 40.

According to some exemplary implementations, engine 22 and battery 48 may be part of an EGR circuit that returns gas from exhaust manifold 24 to intake manifold 20. For example, as shown in FIG. 4, outlet 44 of heat exchanger 40 may be in fluid communication with intake manifold 20. Thus, the path of fluid from exhaust manifold 24 to intake manifold 20 may include a path through heat exchanger 40.

According to some exemplary implementations, vent line 50 may be provided to flow gasses that are not provided to heat exchanger 40 or to intake manifold 42. For example, vent line 50 may lead to one or more of a catalytic converter, muffler, or tailpipe. Having flowed gasses from the exhaust manifold through any desired devices, vent line 50 may eventually vent the gasses to the atmosphere.

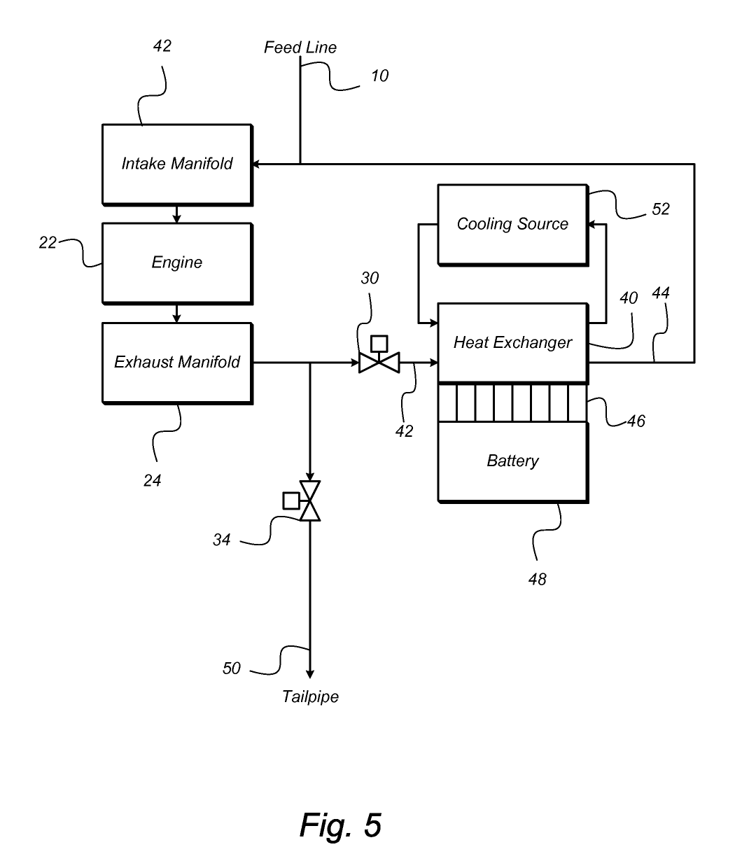

According to some exemplary implementations, a cooling circuit may be provided to heat exchanger 40. As shown in FIG. 5, cooling source 52 may be in fluid communication with heat exchanger 40. Cooling source 52 may be an independent device or part of another cooling system. For example, cooling source 52 may be part of a cooling circuit shared by other devices that may require cooling or other temperature regulation (e.g., hybrid vehicle components, inverter, DC-DC converter, electric generator, etc.). Heat exchanger 40 may be in series or parallel with such other components (not shown) receiving cooling from cooling source 52. Heat exchanger 40 may have a selectively controllable connection with cooling source 52.

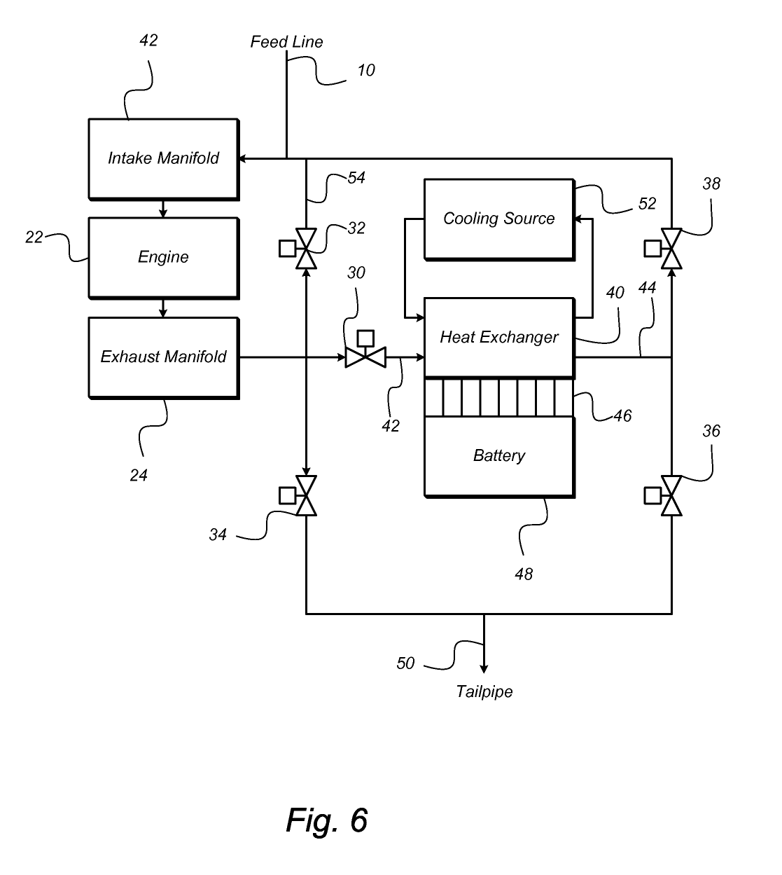

According to some exemplary implementations, as shown in FIG. 6, bypass valve 32 may be provided. Bypass valve 32 may controllably provide gasses from exhaust manifold 24 directly to intake manifold 42 via bypass line 54 where an EGR circuit is desirable but circulation through heat exchanger 40 is undesirable or unnecessary.

According to some exemplary implementations, as shown in FIG. 6, flow from exhaust manifold 24 may be controllably managed through one or more of battery valve 30, bypass valve 32, and first vent valve 34. Other devices and methods of controlling flow are contemplated, including devices that selectively divide the flow from exhaust manifold 24 to heat exchanger 40, vent line 50, and intake manifold 42, according to the proportion of flow desired to be passed to each of the downstream destinations.

According to some exemplary implementations, flow from heat exchanger 40 may be controllably managed through one or both of second vent valve 36 and recirculation valve 38. For example, flow from heat exchanger 40 may be passed through recirculation valve 38 to intake manifold 42 where recirculation to the engine is desirable. By further example, flow from heat exchanger 40 may be passed through vent valve 36 where the recirculation to the engine is undesirable or unnecessary, or where the temperature of gasses from heat exchanger 40 is insufficient to facilitate operation of devices downstream of vent valve 36 (e.g., catalytic converter, etc.).

According to some exemplary implementations, a control system (not shown) may be provided to manage the operation of the exhaust gas recirculation circuit. For example, a control system may store operational settings (e.g., predetermined thresholds), sense operating parameters (e.g., temperatures throughout the system), determine actions to be taken, respond to sensed parameters, and manage components of the system. Thresholds may correspond to sensed operating parameters. The parameters and thresholds may relate to one or more of temperature of the battery, temperature of another component of the system (including gases within the system), impedance of the battery, state of charge of the battery, capacity of the battery, voltage capabilities of the battery, current provided by the battery, power provided by the battery, or any other representation of the system, components thereof, environment, or conditions. Those having ordinary skill in the art will recognize yet other relevant parameters, which are considered within the scope of the present disclosure.

The control system may include components to facilitate such operation, such as processors, memory, temperature sensors, electrical circuitry, and control relationships with components of the exhaust gas recirculation circuit. For example, temperature sensors may be provided at various portions of the exhaust gas recirculation circuit (e.g., at battery 48, exhaust manifold 24, heat exchanger 40, cooling source 52, outlet 44, vent line 50, etc.) to determine the temperatures throughout. By further example, valves and other devices for regulating flow of gasses throughout the exhaust gas recirculation circuit may be managed by the control system.

According to some exemplary implementations, a method is disclosed. The method may include a startup phase, wherein battery 48 may have an initial temperature that is below a predetermined lower threshold or above a predetermined upper threshold. The lower threshold and the upper threshold may define a range of temperatures at which battery 48 may operate with desirable or acceptable performance characteristics. For example, the range of temperatures may be those at which battery 48 performs at a level that is at least a predetermined percentage of its known maximum performance capabilities.

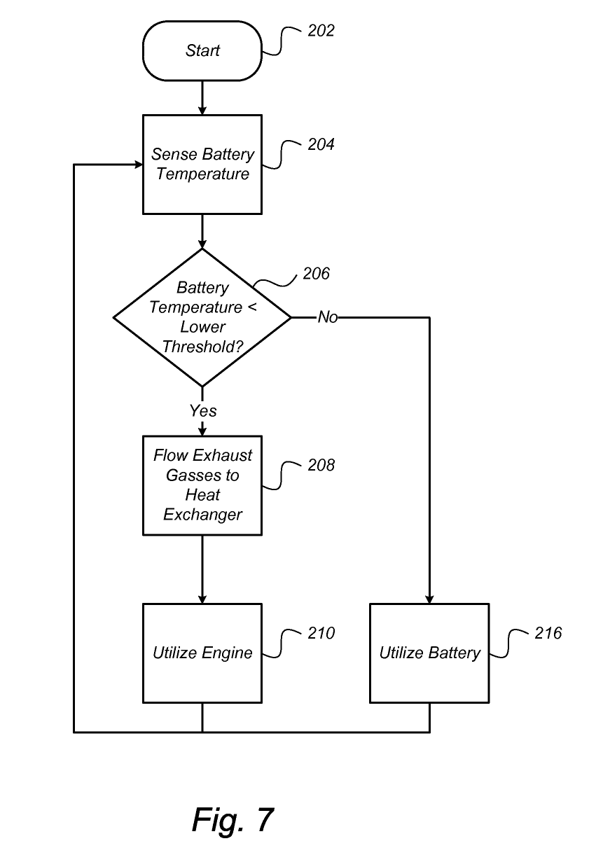

According to some exemplary implementations, as shown in FIG. 7, a method may commence with operation 202. The method may commence as a vehicle is started from a resting (non-operational) state. Alternatively, the method may be commenced during operation of a vehicle.

According to some exemplary implementations, the temperature of the battery may be sensed in operation 204. In operation 206, the sensed temperature of battery 48 may be compared to a lower threshold. If the sensed temperature is lower than the lower threshold, then the system may be configured to flow exhaust gasses from exhaust manifold 24 to heat exchanger 40, whereby the temperature of battery 48 may be raised during operation of engine 22 in operation 210. Further, in operation 210, engine 22 may be utilized to provide power, such that the requirements on battery 48 are reduced until it reaches the lower threshold. Flowing exhaust gasses from exhaust manifold 24 in operation 208 may include at least partially opening battery valve 30.

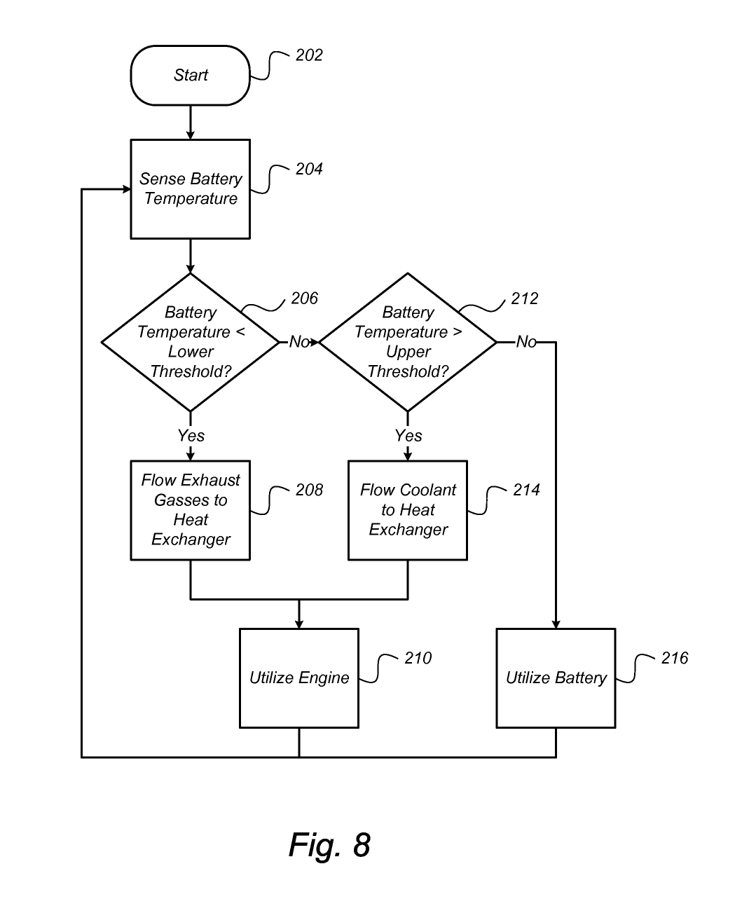

According to some exemplary implementations, as shown in FIG. 8, the sensed temperature of battery 48 may be compared to an upper threshold in operation 212. If the sensed temperature is higher than the upper threshold, then the system may be configured to flow coolant from cooling source 52 to heat exchanger 40 in operation 214, whereby the temperature of battery 48 may be lowered. Further, in operation 210, engine 22 may be utilized to provide power, such that the requirements on battery 48 are reduced until it reaches the upper threshold.

According to some exemplary implementations, the sequence of operation 206 and operation 212 may be reversed or otherwise altered. In like manner, any sensing and computing operations may be performed in any order.

According to some exemplary implementations, during the steady state phase, battery 48 may be utilized. For example, battery 48 may provide power to an electric motor (not shown). A vehicle containing components of the present disclosure may be (at least primarily) operated by engine 22 during the startup phase and (at least primarily) operated by the electric motor during the steady state phase.

According to some exemplary implementations, where the sensed temperature is determined to be above the lower threshold and/or below the upper threshold, battery 48 may be utilized in operation 216. Such utilization of battery 48 may be independent of utilization of engine 22, combined with utilization of engine 22, or any increased measure as compared to alternate operations.

According to some exemplary implementations, regulation of the temperature of batter 48 may be variable. For example, the amount of temperature change effected may be proportionate to the gap between a sensed temperature and a target temperature or temperature range. For example, a magnitude of flow of exhaust gasses or coolant may be variably controlled based on a negative-feedback mechanism, such as by a servomechanism.

According to some exemplary implementations, the predetermined lower and upper threshold temperatures of battery 48 may correspond to temperatures and ranges at which utilization (e.g., discharge or recharge) of battery 48 is safe, efficient, practical, or otherwise desirable. Those skilled in the art will recognize the temperatures at which the predetermined lower threshold may be effective to enhance the performance of battery 48.

According to some exemplary implementations, predetermined upper and lower thresholds may relate to other parameters of the system instead of or in addition to temperature. For example, the system may manage flow until battery 48 reaches a predetermined temperature. By further example, the system may manage flow until battery 48 reaches a predetermined impedance (internal resistance).

According to some exemplary implementations, impedance of battery 48 may be directly sensed and compared to one or both of predetermined lower and upper threshold impedances of battery 48, with action taken according to present disclosure. Likewise, other measurable parameters of battery 48, such as state of charge, age, historical usage, etc. may be sensed and separately or cumulatively employed to determine an action to be taken, as disclosed herein. Accordingly, other lower or upper thresholds corresponding to acceptable or target operating parameters of battery 48 may be predetermined, provided, and applied.

According to some exemplary implementations, efficiency of battery 48 during its utilization may be improved by increasing the temperature thereof. The cost of such efficiency enhancement is low where the heat is provided by sources provided as an inevitable result of the operation of engine 22, as disclosed herein. Thus, the net efficiency of the system is increased by leveraging previously existing conditions (heat of exhaust) to increase the efficiency of other components (battery).

While the method and agent have been described in terms of what are presently considered to be the most practical and preferred implementations, it is to be understood that the disclosure need not be limited to the disclosed implementations. It is intended to cover various modifications and similar arrangements included within the spirit and scope of the claims, the scope of which should be accorded the broadest interpretation so as to encompass all such modifications and similar structures. The present disclosure includes any and all implementations of the following claims.

It should also be understood that a variety of changes may be made without departing from the essence of the disclosure. Such changes are also implicitly included in the description. They still fall within the scope of this disclosure. It should be understood that this disclosure is intended to yield a patent covering numerous aspects of the disclosure both independently and as an overall system and in both method and apparatus modes.

Further, each of the various elements of the disclosure and claims may also be achieved in a variety of manners. This disclosure should be understood to encompass each such variation, be it a variation of an implementation of any apparatus implementation, a method or process implementation, or even merely a variation of any element of these.

Particularly, it should be understood that as the disclosure relates to elements of the disclosure, the words for each element may be expressed by equivalent apparatus terms or method terms—even if only the function or result is the same.

Such equivalent, broader, or even more generic terms should be considered to be encompassed in the description of each element or action. Such terms can be substituted where desired to make explicit the implicitly broad coverage to which this disclosure is entitled.

It should be understood that all actions may be expressed as a means for taking that action or as an element which causes that action.

Similarly, each physical element disclosed should be understood to encompass a disclosure of the action which that physical element facilitates.

Any patents, publications, or other references mentioned in this application for patent are hereby incorporated by reference. In addition, as to each term used it should be understood that unless its utilization in this application is inconsistent with such interpretation, common dictionary definitions should be understood as incorporated for each term and all definitions, alternative terms, and synonyms such as contained in at least one of a standard technical dictionary recognized by artisans and the Random House Webster's Unabridged Dictionary, latest edition are hereby incorporated by reference.

Finally, all referenced listed in the Information Disclosure Statement or other information statement filed with the application are hereby appended and hereby incorporated by reference; however, as to each of the above, to the extent that such information or statements incorporated by reference might be considered inconsistent with the patenting of this/these disclosure(s), such statements are expressly not to be considered as made by the applicant(s).

In this regard it should be understood that for practical reasons and so as to avoid adding potentially hundreds of claims, the applicant has presented claims with initial dependencies only.

Support should be understood to exist to the degree required under new matter laws—including but not limited to United States Patent Law 35 USC 132 or other such laws—to permit the addition of any of the various dependencies or other elements presented under one independent claim or concept as dependencies or elements under any other independent claim or concept.

To the extent that insubstantial substitutes are made, to the extent that the applicant did not in fact draft any claim so as to literally encompass any particular implementation, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative implementations.

Further, the use of the transitional phrase “comprising” is used to maintain the “open-end” claims herein, according to traditional claim interpretation. Thus, unless the context requires otherwise, it should be understood that the term “compromise” or variations such as “comprises” or “comprising”, are intended to imply the inclusion of a stated element or step or group of elements or steps but not the exclusion of any other element or step or group of elements or steps.

Such terms should be interpreted in their most expansive forms so as to afford the applicant the broadest coverage legally permissible.

1. An exhaust gas recirculation circuit comprising:
an engine having an intake manifold and an exhaust manifold; and
a heat exchanger having an inlet in selective fluid communication with the exhaust manifold and an outlet in fluid communication with the intake manifold, wherein the heat exchanger is in a heat exchange relationship with at least a portion of a battery.

2. The exhaust gas recirculation circuit of claim 1, further comprising an outlet of the heat exchange in fluid communication with the intake manifold of the engine.

3. The exhaust gas recirculation circuit of claim 1, further comprising a vent line between the exhaust manifold and the heat exchanger configured to controllably flow at least a portion of the exhaust gasses out of the vehicle.

4. The exhaust gas recirculation circuit of claim 3, wherein the vent line leads to a catalytic converter and a tailpipe.

5. The exhaust gas recirculation circuit of claim 1, wherein the heat exchanger is in a heat exchange relationship with cells of the battery.

6. The exhaust gas recirculation circuit of claim 1, further comprising a bypass valve between the exhaust manifold and the intake manifold.

7. The exhaust gas recirculation circuit of claim 1, further comprising a cooling source in fluid communication with the heat exchanger and configured to selectively provide coolant to the heat exchanger.

8. The exhaust gas recirculation circuit of claim 1, further comprising a bypass line between the exhaust manifold and the intake manifold configured to controllably flow at least a portion of the exhaust gasses from the exhaust manifold to the intake manifold.

9. A method of managing a battery of a hybrid vehicle, comprising:
sensing a parameter of the battery;
comparing the sensed parameter with a lower threshold;
if the sensed parameter is less than a lower threshold, flowing exhaust gasses from an engine to a heat exchanger in a heat exchange relationship with at least a portion of the battery; and
if the sensed parameter is greater than the lower threshold, utilizing the battery.

10. The method of claim 9, wherein the predetermined threshold corresponds to a threshold for satisfying a preferred range of performance characteristics of the battery.

11. The method of claim 9, wherein the sensed parameter is at least one of temperature, impedance, state of charge, age, and historical usage of the battery.

12. The method of claim 9, wherein utilizing the battery further comprises supplying electrical power from the battery to an electric motor, whereby the vehicle is powered by the electric motor.

13. The method of claim 9, further comprising: flowing exhaust gasses from the heat exchanger to an intake of the engine.

14. The method of claim 9, further comprising: comparing the sensed parameter with an upper threshold.

15. The method of claim 14, further comprising: if the sensed parameter is greater than the upper threshold, flowing coolant from a cooling source to the heat exchanger, whereby the temperature of the battery is lowered.

16. The method of claim 14, further comprising: if the sensed parameter is between the lower threshold and the upper threshold, utilizing the battery.

17. A method of managing a battery of a hybrid vehicle, comprising:
sensing a temperature of the battery;
comparing the sensed temperature with a lower threshold and an upper threshold;
if the battery temperature is less than the lower threshold, flowing exhaust gasses from an engine to a heat exchanger in a heat exchange relationship with at least a portion of the battery, whereby the temperature of the battery is raised;
if the battery temperature is greater than the upper threshold, flowing coolant from a cooling source to the heat exchanger, whereby the temperature of the battery is lowered; and
if the battery temperature is between the lower threshold and the upper threshold, utilizing the battery.

18. The method of claim 17, wherein utilizing the battery further comprises supplying electrical power from the battery to an electric motor, whereby the vehicle is powered by the electric motor.

19. The method of claim 17, further comprising: flowing exhaust gasses from the heat exchanger to an intake of the engine.
